(19) United States
(12) Patent Application Publication
(10) Pub. No.: US 2026/0147996 A1
(43) Pub. Date: May 28, 2026

(54) SYSTEM AND METHOD FOR PROCESSING FREE-TEXT QUALITY EVENT DESCRIPTIONS

(71) Applicant: Dan Gebow, Bainbridge Island, WA (US)

(72) Inventor: Dan Gebow, Bainbridge Island, WA (US)

(21) Appl. No.: 19/399,010

(22) Filed: Nov. 24, 2025

Related U.S. Application Data
(60) Provisional application No. 63/724,543, filed on Nov. 25, 2024.

(51) Int. Cl. G06F 40/226; G06F 40/55

(52) U.S. Cl. CPC G06F 40/226; G06F 40/55

(57) ABSTRACT

Systems and methods are provided for processing free-text quality event descriptions. A graphical user interface receives a free-text description of a quality event. A processing engine identifies attributes contained in the description and compares the attributes to a regulatory attribute schema comprising required, conditional, and dependency-linked fields. When missing or ambiguous information is detected, the system generates prompts requesting additional input from the user and receives corresponding responses. A normalization engine standardizes the collected information, and a structuring module converts the normalized information into a machine-readable quality event record. A completeness-validation module determines a completeness score indicating conformity to the regulatory attribute schema. The systems and methods improve the accuracy and consistency of quality event documentation by reducing omissions associated with free-text entry and generating structured records suitable for integration with quality management workflows.

### CROSS-REFERENCE DATA

This application claims the benefit of U.S. Provisional Patent Application No. 63/724,543, filed on Nov. 25, 2024, titled “INTELLIGENT QUALITY EVENT DOCUMENTATION ASSISTANT UTILIZING HISTORICAL DATA AND AI-DRIVEN FEEDBACK,” the entirety of which is incorporated herein by reference.

### BACKGROUND

The present invention relates generally to computer-implemented systems and methods for generating, validating, and structuring quality event documentation. More particularly, the invention relates to systems and methods that receive free-text descriptions of quality events, identify and analyze descriptive attributes referencing regulatory or quality frameworks, and generate machine-readable quality event records through schema-based comparison, dynamic prompting, normalization, and completeness evaluation.

Quality event documentation is a critical component of regulatory compliance, safety assurance, and operational oversight across industries such as aviation, pharmaceuticals, medical devices, manufacturing, energy, and transportation. Organizations operating in these sectors are required to maintain accurate and complete documentation of quality events, which may include procedural deviations, equipment malfunctions, safety issues, contamination incidents, administrative errors, or other occurrences subject to regulatory review.

In current practice, quality event descriptions are frequently entered by personnel with varying levels of training in documentation and regulatory requirements. Free-text entries often omit key information required by regulatory frameworks or internal quality management systems. Missing or ambiguous information in event narratives can impede downstream processes such as risk assessment, root-cause analysis, Corrective and Preventive Action (CAPA) development, or mandatory reporting. Incomplete documentation may also undermine compliance audits, delay investigations, and impair an organization's ability to detect systemic issues or recurring patterns across events.

Manual review of free-text quality event descriptions is time-consuming, subjective, and dependent on the expertise and availability of individual reviewers. Reviewers must identify missing regulatory attributes, solicit clarifications from personnel, and ensure that documentation satisfies schema-defined requirements. Such manual processes do not scale effectively, particularly in environments with high event volumes or limited supervisory resources.

Existing tools in the fields of natural language processing and quality management software typically provide partial or limited support for document analysis and review. These systems often lack the capability to dynamically identify missing regulatory fields, generate precise prompts for clarification, normalize user responses, and construct a machine-readable quality event record aligned with a predefined regulatory attribute schema. Existing approaches further lack mechanisms to determine the completeness of a quality event record based on schema compliance, conditional dependencies, contextual ambiguity, or cross-attribute consistency.

Accordingly, there remains a need for improved systems and methods that can automatically process free-text quality event descriptions, identify missing or ambiguous information relative to regulatory attribute schemas, solicit user clarifications through dynamic prompting, normalize textual content, structure the resulting information into a machine-readable representation, and evaluate the completeness of the resulting record. The present invention addresses these and other shortcomings in the prior art.

### DEFINITIONS

Unless expressly stated otherwise, the following terms, as used herein, have the meanings set forth below. These definitions are provided for purposes of clarity and are not intended to limit the scope of the claimed invention. Additional terms may be defined elsewhere in the specification.

As used herein, “quality event” refers to any occurrence, incident, deviation, anomaly, or observation relevant to a regulatory, safety, compliance, or organizational quality framework, including but not limited to procedural errors, equipment malfunctions, contamination events, safety concerns, or operational deviations.

As used herein, “free-text description” refers to any narrative text provided by a user describing a quality event in an unconstrained linguistic form, including text entered via a graphical user interface, transcribed from speech, extracted through optical character recognition, or obtained through any other suitable input mechanism.

As used herein, “regulatory attribute schema” refers to a structured representation defining required fields, conditional fields, dependency-linked fields, enumerated values, formatting rules, and other constraints that govern the content of a regulatory-or quality-compliant event record.

As used herein, a “conditional field” refers to an attribute within the regulatory attribute schema that is required only when one or more triggering conditions specified by the schema are satisfied by information in the event record.

As used herein, a “dependency-linked field” refers to an attribute whose presence or value is dependent on the presence, absence, or specific content of another attribute defined in the regulatory attribute schema.

As used herein, “event attribute” refers to any linguistic element, term, phrase, temporal expression, entity reference, or descriptive component extracted from a free-text description that corresponds to a field or characteristic defined by the regulatory attribute schema.

As used herein, “normalization” refers to the process of converting free-text content into standardized, schema-compliant representations, including but not limited to converting temporal expressions into timestamps, mapping synonyms to canonical terminology, resolving ambiguous references, correcting typographical errors, and enforcing domain-specific formatting rules.

As used herein, “machine-readable quality event record” refers to a structured representation of event information, including but not limited to a JSON object, XML object, relational schema instance, or any data representation capable of being processed by a quality management system, audit module, or regulatory reporting tool.

As used herein, “completeness score” refers to a quantitative or qualitative measure indicating the degree to which a machine-readable quality event record satisfies the required, conditional, and dependency-linked fields defined by the regulatory attribute schema.

As used herein, “domain-specific language model” refers to a machine-learning model trained or fine-tuned using documents, terminology, or examples associated with a specific industry or regulatory domain, and configured to extract or interpret event attributes from free-text content.

As used herein, “terminology mapping table” refers to any data structure stored in memory that maps user-provided text, synonyms, or alternative expressions to canonical terms defined by the regulatory attribute schema.

As used herein, “audit-trace record” refers to a structured log documenting missing attributes identified during schema comparison, the prompts generated in response, and the user-provided information that addressed each deficiency.

### SUMMARY

Accordingly, it is an object of the present invention to overcome these and other drawbacks of the prior art by providing a novel system and method for constructing a regulatory-compliant quality-event record.

It is another object of the present invention to provide a system and method capable of automatically processing free-text input to generate compliant records.

The present invention relates to systems, methods, and computer-readable media for processing free-text descriptions of quality events and generating structured, schema-compliant event records. In certain embodiments, a graphical user interface receives a free-text description of a quality event. A processing engine identifies event attributes within the free-text description and compares the identified attributes to a regulatory attribute schema that defines required fields, conditional fields, and dependency-linked fields.

When missing or ambiguous information is detected, the system generates one or more prompts requesting additional information from the user and incorporates the user's responses into an evolving representation of the event. In certain embodiments, the processing engine employs a domain-specific language model trained or fine-tuned using historical quality-event records and may compute a linguistic uncertainty score to identify narrative elements requiring clarification.

The system may normalize free-text content by applying rule-based or model-based normalization logic, including converting temporal expressions into discrete timestamps and mapping user-provided terminology to canonical schema terms using a terminology mapping table. The normalized information may then be structured into a machine-readable record that conforms to the regulatory attribute schema. A completeness-validation module evaluates the structured record and assigns a completeness score indicating the degree of conformity. In some embodiments, the system further generates an audit-trace record documenting missing attributes identified during comparison, prompts issued to the user, responses received, and normalization operations performed.

The systems and methods described herein improve the accuracy, completeness, and consistency of quality event documentation while reducing manual review effort and ensuring conformant, machine-readable event records suitable for integration with downstream quality management and regulatory reporting workflows.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an exemplary computing environment and system architecture suitable for implementing the systems and methods described herein.

FIG. 2 illustrates an exemplary high-level workflow for processing a free-text quality event description, including receiving user input, identifying attributes, comparing attributes to a regulatory attribute schema, issuing prompts, and generating a machine-readable quality event record.

FIG. 3 illustrates an exemplary process for identifying attributes contained in a free-text description, comparing those attributes to a regulatory attribute schema, and determining missing or ambiguous information.

FIG. 4 illustrates an exemplary normalization and structuring process, including converting user-provided information into standardized forms and generating a machine-readable quality event record.

FIG. 5 illustrates an exemplary completeness-validation process for determining a completeness score based on schema compliance, dependency satisfaction, and resolution of ambiguous attributes.

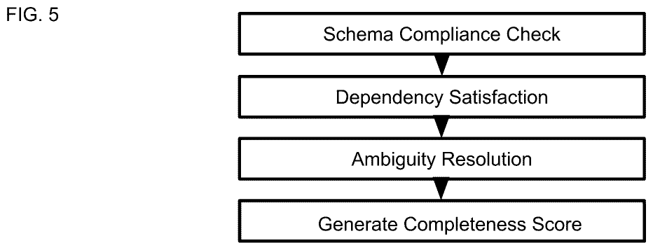

### DETAILED DESCRIPTION OF PREFERRED EMBODIMENTS OF THE INVENTION

The following description sets forth various examples along with specific details to provide a thorough understanding of claimed subject matter. It will be understood by those skilled in the art, however, that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

### Section 1—System Overview and High-Level Architecture

The following description provides an overview of exemplary systems, components, data structures, and operational environments suitable for implementing the methods and systems disclosed herein. It should be understood that the embodiments described in this section are provided solely for purposes of explanation and are not intended to limit the scope of the claimed invention in any manner. Those skilled in the art will appreciate that various modifications, substitutions, and alterations may be made without departing from the spirit or scope of the invention as defined by the claims.

### General Computing Environment

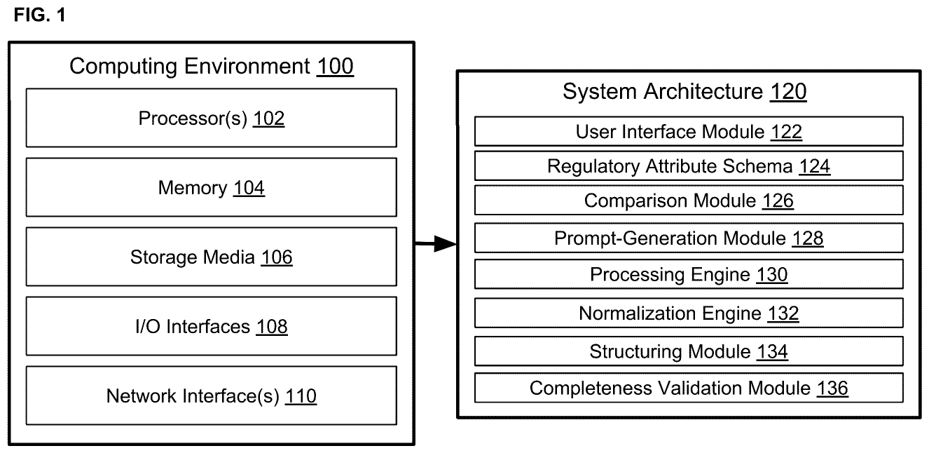

FIG. 1 illustrates an exemplary computing environment 100 suitable for implementing the systems and methods described herein. As shown in FIG. 1, the computing environment may include one or more processors 102, memory 104, non-transitory computer-readable storage media 106, input/output interfaces 108, and network interfaces 110. In some embodiments, the computing environment 100 is implemented on a single physical machine. In other embodiments, the computing environment 100 may comprise multiple servers, distributed cloud computing nodes, on-premises installations, or hybrid combinations thereof.

The processors 102 may be any suitable processing devices, including but not limited to general-purpose CPUs, GPUs, tensor processing units, embedded processors, multi-core processors, or combinations thereof. Memory 104 may include volatile memory (e.g., RAM) and non-volatile memory (e.g., flash storage or ROM). The non-transitory storage media 106 may store program instructions, data structures, schemas, normalization rules, textual content, and machine-readable representations of quality records.

The network interface 110 may facilitate communication with external systems, including user terminals, quality management systems (QMS), compliance databases, regulatory repositories, or cloud-hosted model inference endpoints. In some embodiments, communications may be secured using SSL/TLS protocols, role-based access controls, API keys, authentication tokens, or any combination thereof.

### Overview of System Architecture

FIG. 1 further illustrates an exemplary system architecture 120 comprising functional modules operative to implement the method of processing free-text quality event descriptions. Although shown in a particular arrangement, the modules may be implemented in different configurations, may be combined, subdivided, executed remotely, or distributed across multiple computing resources without departing from the scope of the present invention.

The exemplary system architecture 120 may comprise:
User Interface Module 122, configured to receive free-text quality event descriptions from users and to present prompts for clarification.
Regulatory Attribute Schema 124, defining required fields, conditional fields, dependencies, and structured attributes pertinent to quality events in a given operational domain.
Comparison Module 126, configured to compare free-text content against the regulatory attribute schema to identify missing, incomplete, or ambiguous information.
Prompt-Generation Module 128, configured to generate user-facing prompts to obtain missing or clarifying information.
Processing Engine 130, which may include a natural language model, rule-based logic, or a combination thereof for analyzing user input. In some embodiments, the processing engine 130 includes a domain-specific language model trained or fine-tuned on historical quality-event records. Fine-tuning may be based on prior event narratives, annotated datasets, regulatory reports, or industry-specific documentation. The fine-tuned model may improve attribute extraction accuracy, enhance recognition of specialized terminology, and facilitate interpretation of contextual relationships among descriptive elements within the free-text quality event description.
Normalization Engine 132, configured to standardize and normalize linguistic elements extracted from the user's responses.
Structuring Module 134, configured to generate a machine-readable quality record, including but not limited to JSON, XML, or other structured data formats.
Completeness Validation Module 136, configured to evaluate the completeness of the resulting machine-readable record relative to the regulatory attribute schema.

In some embodiments, the system stores a terminology mapping table in memory. The terminology mapping table may associate user-provided expressions, abbreviations, synonyms, or colloquial terminology with canonical terms defined by the regulatory attribute schema 124. The terminology mapping table may be implemented as a lookup table, dictionary, ruleset, or database structure and may be updated periodically to reflect changes in regulatory terminology or organizational vocabulary.

In some embodiments, any of the modules above may be omitted, duplicated, or replaced with alternative components performing equivalent functions. The invention is not limited to any particular implementation architecture, module order, or delineation of responsibilities among modules.

### High-level Method Flow

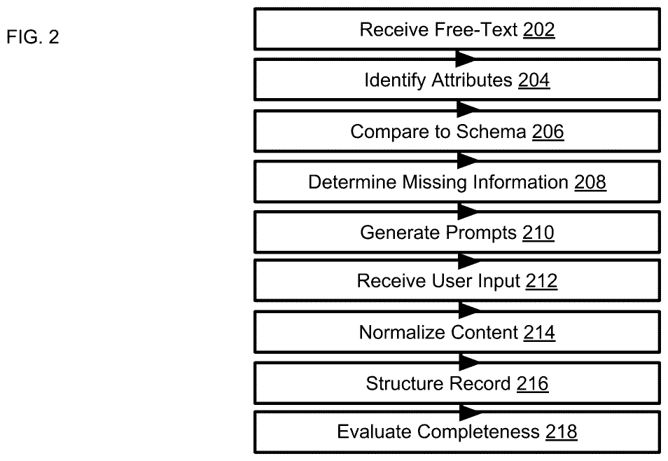

FIG. 2 illustrates an exemplary high-level workflow 200 for processing a free-text quality event description. Although described chronologically, the steps may be performed in a different order, concurrently, iteratively, or conditionally depending on implementation and user behavior.

The workflow 200 may begin with step 202, in which the system receives free-text content describing a quality event via the user interface module 122. In step 204, the system analyzes the content to identify attributes relevant to one or more regulatory, quality, or compliance frameworks. In step 206, the system compares the extracted content to the regulatory attribute schema 124. In step 208, the system determines whether any required, conditional, or dependency-linked fields are missing or incomplete.

If missing information is detected, step 210 involves generating prompts to obtain additional clarification from the user. In step 212, the system receives additional input responsive to these prompts and incorporates the newly provided information. In step 214, the normalization engine 132 standardizes and normalizes the content. In step 216, the structuring module 134 converts the normalized content into a machine-readable quality record. In step 218, the completeness validation module 136 evaluates the record and assigns a completeness score.

The workflow then concludes at step 220, where the system outputs the structured record and associated completeness score.

### Data Structures and Schemas

In some embodiments, the regulatory attribute schema 124 may include:
lists of required fields
conditional field rules
dependency relationships
enumerated acceptable values
free-text fields with formatting requirements
date/time field specifications
equipment, personnel, or procedural identifiers
narrative or root-cause elements

In some embodiments, the regulatory attribute schema 124 may further specify rules for extracting temporal expressions and converting such expressions into discrete timestamps. Temporal expressions may include explicit references, relative references, or ambiguous expressions that require normalization before being populated into a machine-readable quality event record.

The schema may be stored in memory 104 or non-transitory computer-readable media 106 and may be updated periodically to reflect changes in regulatory requirements, organizational policies, or industry practices. Those skilled in the art will appreciate that the schema may be defined in YAML, JSON, XML, SQL-backed structures, proprietary domain-specific languages (DSLs), or other formats.

### Regulatory Attribute Schema

In certain embodiments, the system employs a regulatory attribute schema that defines the structural, contextual, and dependency requirements associated with quality event reporting. The schema may be implemented as a structured data model stored in memory or on a non-transitory computer-readable medium, and may be represented in any machine-readable format, including JSON, XML, YAML, relational tables, or proprietary schema formats. The schema may be retrieved by the system at runtime and updated periodically to reflect changes in organizational policy, regulatory frameworks, historical event patterns, or system-learned refinements.

In some embodiments, the schema defines a plurality of attribute classes, including required fields, conditionally required fields, dependency-triggered fields, enumerated fields, free-text narrative fields, and timestamp fields. Each attribute may include metadata such as data type, value constraints, formatting rules, acceptable vocabularies, semantic relationships to other attributes, or validation logic. For example, a required field may include a component identifier, while a dependent field may include the method used to verify a corrective action when an action is detected in the event description.

In other embodiments, the schema includes rule constructs that define logical dependencies among attributes. Dependencies may specify that the presence of one attribute activates a requirement to supply a secondary attribute. For example, the presence of a component failure may activate a requirement to supply inspection time, verification method, and personnel identifier. The dependency logic may be bidirectional or multi-layered, enabling nested requirements where the activation of one dependent attribute triggers additional fields.

The schema may also include a taxonomy of domain-specific terminology and canonical vocabularies. This taxonomy may be used by the normalization engine to map user-supplied terminology onto canonical attribute names, enumerated values, or standardized domain categories. In some embodiments, the schema may include synonym tables, linguistic equivalency rules, morphological variants, or cross-references to technical dictionaries or regulatory glossaries.

In certain embodiments, the schema defines validation sequences that determine whether a structured quality event record satisfies all required and conditional fields. Such validation sequences may include field-level validation, record-level validation, temporal consistency checks, and semantic plausibility checks based on historical event patterns. The completeness-validation module may compute a completeness score based on the degree to which the structured record conforms to the schema's requirements.

In further embodiments, the schema may be dynamically updated based on analytical outputs generated by the system, including root-cause analyses, classification patterns, simulation results, or benchmarking data. These updates may include modifying attribute dependencies, adding new attributes, retiring obsolete ones, adjusting canonical values, or updating configuration parameters. Such updates may be applied automatically, manually, or through a hybrid human-in-the-loop mechanism.

The schema may be stored as a version-controlled data structure to ensure that historical quality event records remain consistent with the schema version applied at the time of their creation. The system may maintain both current and historical schema versions and apply the correct version automatically based on the event timestamp, reporting requirements, or organizational policy.

This expanded description provides robust support for the various schema-related operations described elsewhere in the specification, including attribute extraction, dependency detection, prompt generation, normalization, record structuring, and completeness scoring.

### EXAMPLE 1

### End-to-End Processing of a Free-Text Quality Event Description

The following example illustrates one non-limiting embodiment of the systems and methods described herein. The example is provided solely for purposes of explanation and is not intended to limit the scope of the claimed invention. Any of the modules, operations, or data structures described below may be omitted, substituted, reordered, or supplemented in other embodiments.

### 1. Initial Free-Text Input

In this example, a user accesses the graphical user interface and enters the following free-text description of a quality event:

“Found a loose panel on the right wing during inspection. Fixed it before the flight.”

Upon receipt of this input, the processing engine generates an initial parsed representation. The parsed representation includes identified equipment references (“panel,” “right wing”), an action reference (“fixed”), and a procedural reference (“inspection”). The system also determines that the free-text description lacks several fields required by the applicable regulatory attribute schema, including component identifier, technician identifier, inspection timestamp, and verification method for the corrective action.

### 2. Schema Comparison and Detection of Missing Information

The comparison module retrieves the regulatory attribute schema from memory and applies schema-defined validation rules. In this example, the schema specifies that when an equipment component is referenced, a corresponding part number, assembly code, or position identifier must also be supplied. Because the free-text content does not include such information, the system identifies a missing attribute.

The schema further defines dependencies whereby the presence of a corrective action activates a requirement to document the method of verification. The system, therefore, identifies a second missing attribute relating to verification. Additionally, the schema includes a required field for personnel identification and a field for the time of inspection, both of which are absent from the free-text input.

### 3. Prompt Generation and User Interaction

Based on the missing fields identified above, the prompt-generation module generates a sequence of clarifying prompts. The prompts are derived from template rules, natural-language model inference, or a combination thereof. In this example, the following prompts are issued through the graphical user interface:
“Please specify the panel or component, including part number or system designation.”
“Please identify the individual who performed the corrective action.”
“At what time did the inspection occur?”
“What verification method was used to confirm that the corrective action was effective?”

The user provides the following responses:
“Panel 4B on the right wing.”
“Technician ID 543.”
“Inspection was at 07:45.”
“Performed a torque check and visual inspection.”

Based on the verification method supplied by the user, a dependency in the schema triggers an additional rule requiring identification of tools used, resulting in a further prompt:
“Please identify the tool(s) used during verification.”

The user responds: “Torque wrench, calibrated last month.”

### 4. Normalization Operations

The normalization engine processes both the initial free-text description and the user-provided clarifications. In this example, normalization operations include:

### Terminology Standardization

“Loose panel” is mapped to a canonical maintenance category “panel detachment.”
“Fixed” is mapped to “corrective action performed.”

### Entity Resolution

The pronoun “it” in “fixed it before the flight” is resolved to “panel 4B.”

### Temporal Normalization

“Inspection was at 07:45” is converted into a standardized ISO-formatted timestamp.

If date context is unavailable, the system may request clarification or infer date from session metadata.

### Tool Normalization

“Torque wrench, calibrated last month” is mapped to structured fields representing tool type and calibration state.

### Verification Method Normalization

“Torque check and visual inspection” is normalized into a schema-defined enumerated list.

Each normalization step may produce an intermediate representation logged in the audit-trace module.

### 5. Structuring the Quality Event Record

Once normalization is completed, the structuring module constructs a machine-readable quality event record conforming to schema format requirements. In this example, the resulting structured record includes fields such as:
EVENT_TYPE: STRUCTURAL
COMPONENT_IDENTIFIER: PANEL 4B
COMPONENT_LOCATION: RIGHT WING
INSPECTOR_IDENTIFIER: TECHNICIAN 543
INSPECTION_TIMESTAMP: 2024-04-02T07:45:00Z
CORRECTIVE_ACTION: TIGHTENED PANEL
VERIFICATION_METHODS: [“TORQUE CHECK”, “VISUAL INSPECTION”]
TOOLS_USED: [“TORQUE WRENCH (CALIBRATED)”]
INITIAL_DESCRIPTION_TEXT: “FOUND A LOOSE PANEL ON THE RIGHT WING DURING INSPECTION. FIXED IT BEFORE THE FLIGHT.”
NORMALIZED_SUMMARY: “PANEL DETACHMENT CORRECTED ON RIGHT WING; VERIFICATION PERFORMED.”

The structuring module enforces field-level constraints, verifies enumerated-value compliance, and confirms that all required and conditional fields have been satisfied.

### 6. Completeness Evaluation

The structured record is passed to the completeness-validation module. The module applies schema rules and determines:
all required fields have been supplied;
all conditional and dependency-linked fields have valid values;
all ambiguities identified earlier have been resolved;
the structured record conforms to formatting rules.

In this example, the completeness score is computed as 100%.

### 7. Audit-Trace Record

An audit-trace record is generated to reflect the sequence of operations performed during processing. In this example, the audit-trace record includes entries such as:
“Missing attribute detected: component identifier.”
“Prompt issued: specify part number.”
“User response recorded: Panel 4B.”
“Normalization applied: ‘loose panel’→‘panel detachment’.”
“Temporal parsing: 07:45→2024-04-02T07:45:00Z.”
“Dependency triggered: verification tools required.”
“Completeness score computed: 100%.”

The audit-trace record may be exported, stored, or transmitted along with the structured quality event record.

### 8. Final Output

The system outputs:
1. the machine-readable structured quality event record;
2. the completeness score; and
3. the audit-trace record.

These outputs may be sent to a downstream quality management system, compliance database, or reporting pipeline.

### LLM and Rule-Based Processing Considerations

The processing engine 130 may employ a large language model, a rule-based system, a hybrid framework, or any combination thereof. In some embodiments, the processing engine includes one or more transformer-based models pretrained on general corpora and subsequently fine-tuned using domain-specific examples of quality event descriptions. In other embodiments, no fine-tuning is required; instead, the engine may rely on prompt engineering, retrieval-augmented generation, or contextual embeddings sourced from historical databases.

In still further embodiments, the processing engine 130 may invoke:
synonym expansion rules
temporal normalization rules
grammatical or typographic correction logic
ambiguity detection heuristics

In certain embodiments, the processing engine 130 may compute a linguistic uncertainty score for one or more phrases, clauses, or extracted attributes. The linguistic uncertainty score may indicate the degree of ambiguity, incompleteness, or contextual uncertainty present in the free-text description. Such a score may be generated using probabilistic language-model inference, confidence metrics associated with attribute extraction, or rule-based heuristics, and may be used to determine whether additional clarification prompts should be generated.
pattern-matching algorithms
entity extraction models

The invention is not limited to any particular AI model, inference strategy, or rule engine.

### Security, Compliance, and Deployment Considerations

In some embodiments, implementations may include mechanisms for:
access control
audit trails
encryption at rest and in transit
data retention policies
versioning of schemas and models
event logs for quality assurance

The system may be deployed in compliance with regulatory frameworks governing quality event reporting, including aviation, medical device, pharmaceutical, or manufacturing standards.

### Section 2—Detailed Description of the Method

The following description provides a detailed, step-by-step explanation of an exemplary method for processing a free-text quality event description. This description is intended to be read in conjunction with the system architecture described in Section 1 and the functional modules illustrated in FIGS. 1-4. Those skilled in the art will understand that the steps described herein may be modified, reordered, omitted, or supplemented without departing from the scope of the claimed invention.

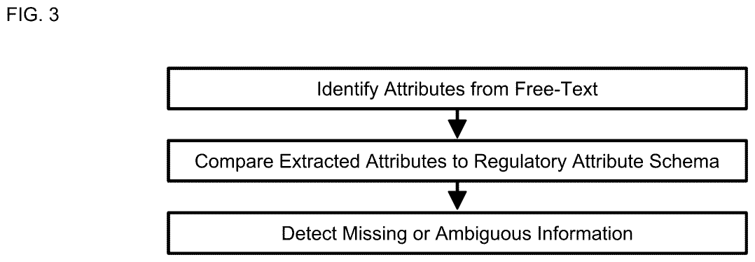

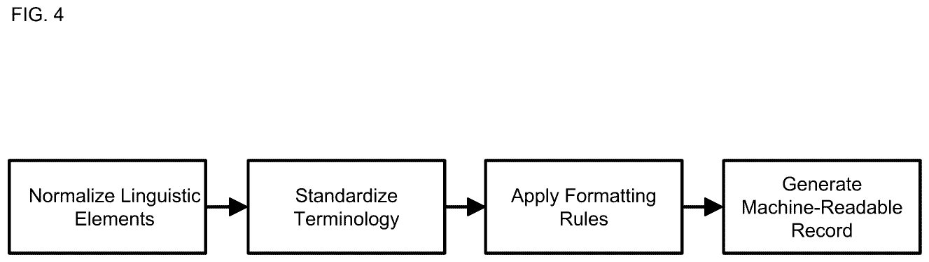

FIG. 2 illustrates a high-level workflow for carrying out the method. FIG. 3 provides additional detail regarding comparison of free-text content to a regulatory attribute schema. FIG. 4 illustrates exemplary processing associated with normalization and structuring of the resulting quality event information.

### 2.1 Receiving a Free-Text Description of a Quality Event

In step 302 of FIG. 3, the method begins by receiving, via a graphical user interface (GUI), a free-text description of a quality event. The free-text description may be entered into a single text field, multiple text fields, or a rich text interface configured to capture narrative descriptions. The GUI may be presented on a workstation, laptop, tablet, mobile device, or any computing device capable of transmitting user input to the system.

In some embodiments, the GUI may support additional input modalities, including but not limited to:
voice-to-text transcription,
uploading scanned or handwritten records with OCR preprocessing,
structured prompts that accompany the free-text entry,
auto-save and draft management features.

Those skilled in the art will appreciate that the method is not limited to any particular interface design, input device, or data transmission mechanism.

### 2.2 Identifying Attributes in the Free-Text Description Referencing a Regulatory, Quality, or Compliance Framework

As shown in step 304 of FIG. 3, upon receiving the user's free-text content, the system analyzes the text to identify descriptive elements that correspond to one or more attributes defined in a regulatory or quality-related framework. Such attributes may include, without limitation:
the nature of the event (e.g., procedural deviation, equipment malfunction, contamination, administrative error),
actors or personnel involved,
equipment or materials referenced,
dates, times, and temporal relationships,
actions taken in response to the event,
operational environment or location,
circumstances relevant to root-cause analysis.

In some embodiments, identification of attributes may be achieved using natural language processing models, pattern-matching heuristics, domain-specific rule sets, statistical methods, or combinations thereof. In still further embodiments, the analysis may incorporate industry-specific terminologies, ontologies, or historical examples of quality event documentation to improve robustness.

In some embodiments, the processing engine may further analyze the free-text description to identify temporal expressions, ambiguous narrative elements, and contextual indicators that may influence regulatory requirements. Temporal expressions may include explicit references, relative phrases, or ambiguous indicators requiring subsequent normalization. Ambiguity in the narrative may be flagged for additional analysis prior to schema comparison.

### 2.3 Comparing Identified Content to a Regulatory Attribute Schema

As shown in step 306 of FIG. 3, the method includes comparing the identified content extracted from the free-text description to a regulatory attribute schema. The regulatory attribute schema may include:
required fields,
conditional fields subject to dependency rules,
enumerated values,
structured identifiers,
fields associated with organizational policies,
compliance thresholds,
cross-field consistency requirements.

The comparison may include determining the presence, absence, or ambiguity of each attribute. For example, the schema may specify that a “corrective action taken” field is required only if the event description indicates immediate mitigation. Similarly, the schema may require timestamp precision if the event involves a time-sensitive process.

In some embodiments, the comparison may generate a field-level analysis table identifying:
attributes present in the free-text content,
attributes missing but required,
attributes present but inconsistent with schema constraints,
dependencies that are triggered but not satisfied.

Those skilled in the art will recognize that the comparison process may be performed iteratively or incrementally and may maintain an evolving set of completeness indicators throughout the method.

### 2.4 Determining Missing or Ambiguous Information

Step 308 of FIG. 3 illustrates the determination of whether any required attribute, conditional attribute, or dependency-linked field is missing or ambiguous. Missing information may include the complete absence of a required field, while ambiguous information may include partial, contradictory, or unclear references.

Examples of missing or ambiguous information include, without limitation:
references to actions without specifying actors,
incomplete timestamps (e.g., “in the morning” or “sometime last week”),
unspecified equipment identifiers,
vague statements such as “the issue was fixed,”
multiple possible interpretations of an event sequence.

In certain embodiments, the system may compute a linguistic uncertainty score associated with one or more phrases, clauses, or extracted attributes in the free-text description. The linguistic uncertainty score may represent a confidence value or probabilistic measure indicating the degree of ambiguity or contextual uncertainty detected in the text. The system may use this score to determine whether a particular attribute requires additional clarification and whether a corresponding prompt should be generated.

In some embodiments, ambiguity detection may include evaluating linguistic uncertainty, conflicting references, inconsistent tense usage, or incomplete causal structures.

### 2.5 Generating Prompts for Additional Information

As shown in step 310 of FIG. 3, when missing or ambiguous information is detected, the method includes generating prompts to solicit additional user input. The prompts may be generated by the prompt-generation module and may reference:
missing attributes,
ambiguous clauses,
conditional fields triggered by earlier statements,
schema-defined dependencies,
temporal sequencing gaps,
equipment or personnel identifiers requiring refinement.

In some embodiments, prompts may be dynamically generated using a natural language model. In other embodiments, prompts may be drawn from a predefined library of clarification templates. Prompts may be presented sequentially, in parallel, or adaptively based on user responses.

Those skilled in the art will appreciate that prompt ordering, phrasing, and level of specificity may be adjusted to accommodate regulatory expectations, organizational preferences, or user expertise.

### 2.6 Receiving Additional Free-Text Input From the User

Step 312 of FIG. 3 illustrates the receipt of additional free-text input from the user in response to the prompts. The additional input may be collected through the same GUI as the original entry. The system may continue issuing additional prompts until attribute-level completeness is achieved or until predefined stopping conditions are met.

In some embodiments, the system may also track whether user-provided clarifications introduce new missing dependencies. For example, identifying a new piece of equipment may require corresponding fields regarding inspection, calibration, or maintenance history.

The method is not limited to any particular number of iterative prompt cycles.

### 2.7 Normalizing Information From the Received Text

As shown in FIG. 4 (step 402), once all required or prompted information is gathered, the method includes normalizing the information into standardized forms. Normalization may include:
converting dates and times into fixed formats,
mapping synonyms to canonical terms,
standardizing terminology to match schema expectations,
correcting spelling or typographic errors,
resolving pronouns into explicit references,
restructuring narrative content into attribute-specific representations.

For example, statements such as “yesterday afternoon” may be normalized to a specific date and time. Statements referencing “the machine” may be replaced with specific equipment identifiers based on context.

Normalization may be performed using rule-based engines, machine learning models, or hybrid approaches.

In some embodiments, the normalization engine may extract temporal expressions and convert them into discrete timestamp fields suitable for inclusion in the machine-readable quality event record. Temporal normalization may include interpreting relative expressions such as “yesterday afternoon” or “earlier in the shift,” resolving ambiguous references using contextual cues, and converting the interpreted expressions into standardized date and time formats defined by the regulatory attribute schema.

2.8 Structuring Information into a Machine-Readable Quality Record

Step 404 of FIG. 4 illustrates structuring the normalized information into a machine-readable quality record. In some embodiments, structuring may comprise populating a JSON or XML template. The structured record may include:
event metadata,
actor and equipment identifiers,
timestamp fields,
causal descriptions,
actions taken,
clarifications generated during prompting,
fully normalized text fields.

The method does not require the use of a particular structured format; any representation compatible with an external compliance or quality management system may be used.

In some embodiments, the structuring module may validate field formats and enforce schema constraints before finalization.

### 2.9 Assessing and Applying a Completeness Score

As shown in step 406 of FIG. 4, the method includes determining a completeness score for the structured quality record. The completeness score may be represented as a numerical value, percentage, categorical level, or other metric indicating the record's conformity to the regulatory attribute schema.

Completeness scoring may include evaluating:
presence of required fields,
fulfillment of conditional dependencies,
clarity of causation,
resolution of ambiguities,
adherence to schema formatting,
adequacy of temporal sequencing,
presence of mitigation or containment information when expected.

Those skilled in the art will appreciate that completeness scoring may be configurable and may be adapted to reflect regulatory updates or internal quality policies.

In some embodiments, the system may additionally record information associated with missing attributes identified during the comparison process, the clarification prompts generated in response, and the corresponding user-provided inputs. Such information may be used in downstream processes, including generation of an audit-trace record, as described elsewhere in this specification.

### 2.10 Output and Optional Post-Processing

The structured quality record and completeness score may be displayed to the user, transmitted to downstream systems, stored in audit logs, or incorporated into broader quality management workflows. The method may also perform optional post-processing, including:
generating automated summaries,
triggering internal workflows,
preparing information for risk assessment,
integrating with CAPA or RCA systems.

### Section 3—Description of the Non-Transitory Computer-Readable Medium

According to some embodiments, a non-transitory computer-readable medium stores executable instructions which, when executed by one or more processors, cause the processors to perform the method steps described in Section 2. The non-transitory computer-readable medium may include any tangible storage device capable of storing instructions, including but not limited to magnetic storage devices, optical media, semiconductor memory, flash memory, solid-state drives, or combinations thereof. The medium is expressly non-transitory and excludes signal-bearing carrier waves or purely transitory forms of signal transmission.

In certain embodiments, the non-transitory computer-readable medium stores program instructions encoded in machine-readable form. When executed, the instructions cause a computer system to receive, via a graphical user interface, free-text information describing a quality event. The instructions may further cause the system to identify within the free-text information attributes that reference a regulatory, quality, or compliance framework.

In some embodiments, the instructions stored on the non-transitory computer-readable medium may direct the processors to utilize a domain-specific language model trained or fine-tuned on historical quality-event records. Such instructions may enable the processors to apply inference operations using the fine-tuned model in order to improve recognition of specialized terminology, enhance the extraction of event attributes, and support contextual interpretation of narrative structures associated with quality event documentation.

The instructions may additionally cause the processors to compare the identified attributes to a regulatory attribute schema stored in memory. Such comparison may include determining the absence of required fields, the activation of dependency-linked fields, the identification of conditional fields lacking values, or the presence of ambiguous narrative elements requiring clarification.

In some embodiments, the instructions stored on the computer-readable medium cause the processors to generate prompts requesting additional information from a user. The prompt-generation instructions may access a library of predefined templates, apply natural-language model inference, or utilize rule-based logic to formulate clarifying questions. The instructions may additionally cause the processors to compute a linguistic uncertainty score associated with extracted attributes or narrative segments, thereby determining whether ambiguity thresholds warrant the generation of supplemental prompts.

The instructions may further cause the processors to receive additional information from the user in response to one or more prompts, incorporate such information into an evolving representation of the event, and track newly triggered schema dependencies arising from user input. In some embodiments, the instructions may maintain a record of which prompts were issued and which user responses were applied, enabling downstream audit-related functionality.

According to some embodiments, the non-transitory medium stores instructions for normalizing the information received from the user. Normalization instructions may include operations for converting temporal expressions into standardized timestamps, mapping free-text terminology to canonical schema terms, resolving ambiguous pronouns or references, and rectifying inconsistencies in terminology. Additional normalization instructions may include performing entity extraction, validating linguistic patterns, detecting inconsistencies between attributes, or correcting typographical or grammatical errors as required to satisfy schema expectations.

In certain embodiments, the instructions stored on the non-transitory computer-readable medium may cause the processors to extract temporal expressions from the free-text description or user-provided clarifications and convert such expressions into discrete timestamp fields. The instructions may apply rule-based parsing, contextual inference, or machine-learning-based temporal interpretation to convert explicit, relative, or ambiguous expressions into standardized timestamps compatible with the regulatory attribute schema.

In further embodiments, the non-transitory medium stores instructions for applying a terminology mapping table stored in memory. The terminology mapping table may associate user-provided expressions, abbreviations, synonyms, or colloquial terminology with canonical schema-defined terms. The mapping table may be implemented as a lookup table, dictionary, or ruleset, and the instructions may invoke the mapping table during normalization or structuring operations to ensure schema conformity.

The non-transitory medium may also store instructions for structuring normalized information into a machine-readable format. Such instructions may populate a template such as a JSON object, XML structure, or other definable schema. Structuring instructions may enforce field-level constraints, ensure compliance with schema-defined formats, and validate that required or conditional fields have been satisfied. In some embodiments, the structuring instructions may additionally include logic for encoding sequential user clarifications, historical provenance, or metadata relevant to auditability.

The medium may additionally store instructions for generating a completeness score associated with the structured quality event record. Such instructions may evaluate whether each required attribute is present, whether conditional dependencies have been satisfied, whether ambiguities have been resolved, and whether the structured representation adheres to the regulatory attribute schema. Completeness scoring instructions may compute numerical or categorical values indicating the level of conformity.

In some embodiments, the non-transitory medium further stores instructions for generating or updating an audit-trace record. Such instructions may cause the processors to document missing attributes identified during schema comparison, prompts issued to the user, user-provided clarifications, normalization operations applied to the information, and the results of schema validation. The audit-trace record may be stored in memory or exported to external audit or compliance systems.

The non-transitory medium may further store instructions for outputting the structured quality event record and its associated completeness score to a display, external system, or storage device. Output instructions may include formatting, serialization, encryption, or transmission operations suitable for integration with quality management systems, audit tools, or regulatory reporting pipelines.

Those skilled in the art will appreciate that the instructions stored on the non-transitory computer-readable medium may be executed sequentially, concurrently, or in a pipeline configuration. Furthermore, the instructions may be executed in distributed environments, containerized environments, serverless architectures, or conventional single-machine deployments. The invention is not limited to any particular system topology, processor type, memory configuration, or underlying software architecture.

The non-transitory computer-readable medium may store additional instructions not explicitly enumerated herein, provided that such instructions are operable to facilitate, enhance, or support execution of the method steps claimed. Optional instructions may include those for user authentication, role-based access control, localization of prompts, regulatory schema version management, audit log export, or integration with external quality management platforms. The presence or absence of such optional instructions does not limit the scope of the invention.

### Section 4—System Description and End-to-End Example

According to some embodiments, a system is provided for processing a quality event description. FIG. 1 illustrates an exemplary configuration of such a system, although the invention is not limited to any particular physical or logical arrangement. The system may include one or more computing devices, servers, or distributed resources, each operative to execute the functions described herein. The system may further include one or more databases, data stores, or memory structures for storing regulatory schemas, normalization rules, terminology mapping tables, user input, audit-trace information, and machine-readable representations of quality event records.

In some embodiments, the system comprises a graphical user interface configured to receive free-text information describing a quality event. The graphical user interface may be displayed on a workstation, laptop computer, mobile device, tablet, or any computing device capable of presenting input fields to a user. The graphical user interface may include a text entry region, optional toolbar elements for editing or expanding text, and controls for submitting, reviewing, or modifying user input. Those skilled in the art will appreciate that the graphical user interface may be implemented in a web-based environment, native application environment, client-server environment, or any other conventional architecture.

The system may further comprise a processing engine configured to identify, within the free-text information, one or more attributes referencing a regulatory, quality, or compliance framework. The processing engine may include a natural language model, pattern-recognition module, rule-based classifier, or any combination thereof. In certain embodiments, the processing engine may include or invoke a domain-specific language model trained or fine-tuned using historical quality-event records. Such fine-tuning may enhance recognition of specialized terminology, improve attribute extraction accuracy, and support contextual interpretation of narrative structures commonly found in quality event descriptions. The engine may generate intermediate data structures such as tokenized representations, dependency trees, uncertainty scores, or semantic frames, although the invention is not limited to any particular linguistic representation.

In some embodiments, the processing engine may compute a linguistic uncertainty score for one or more extracted attributes or narrative segments. The uncertainty score may indicate the degree of ambiguity, incompleteness, or contextual uncertainty present in the text. The linguistic uncertainty score may be used to determine whether the prompt-generation module should request additional information from the user.

According to some embodiments, the system includes a comparison module configured to compare the identified attributes to a regulatory attribute schema. The comparison module may be implemented using rule-based logic, table-driven schema evaluation, or an inference engine configured to verify that schema-defined requirements are satisfied. The comparison module may determine when a required field is missing from the free-text content, when a conditional dependency is activated but lacks a corresponding value, or when the provided content exhibits ambiguity requiring clarification.

In some embodiments, the system further comprises a prompt-generation module configured to generate at least one prompt for requesting additional information from the user. The prompt-generation module may utilize predefined prompt templates, dynamically generated natural-language questions, schema-linked clarification requests, or context-sensitive messages derived from a natural language model. The module may additionally prioritize prompts based on regulatory requirements, severity indicators, uncertainty scores, or historical clarification patterns.

The system may also comprise a normalization engine configured to normalize the information contained in the free-text description and the responses received from the user. Normalization may include converting dates, times, or numbers into standardized formats; resolving pronouns or ambiguous references; mapping user-provided terms to canonical schema vocabulary using a terminology mapping table; and conforming the narrative content to expected syntactic or semantic structures. In some embodiments, the normalization engine may include an entity resolver, a temporal normalizer configured to extract and interpret temporal expressions and convert them into discrete timestamp fields, a synonym expander, or a dictionary-based correction module.

According to certain embodiments, the system includes a structuring module configured to structure the normalized information into a machine-readable quality event record. The structuring module may populate a JSON template, XML template, or any other structured representation of the event. The structured record may include metadata, event attributes, causal chains, personnel identifiers, equipment identifiers, timestamps, verification methods, and narrative descriptions as required by the regulatory attribute schema. In some embodiments, the structuring module may further perform schema validation prior to finalizing the structured record and may record metadata needed for downstream audit functionality.

The system may also include a completeness-validation module configured to determine a completeness score associated with the structured quality event record. The completeness-validation module may evaluate whether required fields are present, whether conditional and dependency-linked fields are satisfied, whether ambiguities have been resolved, whether timestamps and terminology conform to schema requirements, and whether the structured record adheres to formatting and content rules defined by the regulatory attribute schema. The completeness score may be represented as a percentage, categorical label, or numerical value.

In certain embodiments, the system may generate an audit-trace record documenting processing operations performed during the creation of the machine-readable quality event record. The audit-trace record may include identifiers of missing or ambiguous attributes detected during schema comparison, prompts generated to address those deficiencies, user-provided responses, normalization operations applied—including timestamp conversion and terminology mapping—and the results of schema validation. The audit-trace record may be stored within the system or transmitted to external audit, compliance, or quality management platforms.

Those skilled in the art will appreciate that the modules described herein may be implemented as distinct components or integrated into shared processing elements. The modules may execute on a single physical machine, distributed cluster, virtualized environment, containerized platform, or hybrid cloud environment. The invention is not limited to any particular deployment configuration.

The following example illustrates an end-to-end operation of the system. The example is provided solely for purposes of illustration and is not intended to limit the scope of the claimed invention.

In the exemplary scenario, a user initiates a session by accessing the graphical user interface displayed on a workstation. The user enters the following free-text description into the text entry region: “Found a loose panel on the aircraft during inspection. Fixed it before the flight.” Upon receiving this input, the processing engine identifies references to an equipment component (“panel”), an action taken (“fixed”), and an inspection procedure. However, the engine also determines that the description lacks information required by the regulatory attribute schema, including the specific component identifier, the name or role of the individual performing the fix, the exact time of the inspection, and the method used to confirm that the corrective action was adequate.

The comparison module compares the identified attributes to the regulatory attribute schema and determines that at least four required or conditional fields are missing. The prompt-generation module generates corresponding prompts, including: “Please identify the specific panel or component by part number or system designation.”; “Who performed the corrective action?”; “At what time did the inspection occur?”; and “What verification method was used to confirm that the corrective action resolved the issue?”

The user enters responses such as “Panel 4B on the right wing,” “Technician ID 543,” “Inspection was at 07:45,” and “Performed a torque check and visual inspection.” These responses are received by the graphical user interface and transmitted to the processing engine. The processing engine incorporates the new information and evaluates whether any additional dependencies are triggered. In this example, requiring a verification method also triggers a requirement to document any tools used. The prompt-generation module therefore issues an additional prompt requesting tool identification. The user responds with “Torque wrench, calibrated last month.”

The normalization engine processes the initial description and the user's subsequent responses. Temporal expressions are converted into standardized timestamps. Personnel identifiers are mapped to canonical schema fields. Equipment identifiers are standardized. User-provided terminology is mapped through the terminology mapping table to canonical schema terms. Ambiguous references such as “it” are resolved to specific components or actions based on context.

The structuring module then structures the normalized information into a machine-readable quality event record. The resulting record may include fields such as event type, equipment identifier, technician identifier, timestamp of inspection, description of corrective action, verification method, tool usage, and associated metadata. The structuring module validates the structured record against the regulatory attribute schema to ensure conformity.

The completeness-validation module evaluates the structured record and assigns a completeness score. In this example, because all required fields, conditional fields, and dependencies have been satisfied, the completeness score may be assigned as 100%. The system outputs the structured quality event record and the completeness score to the user and may optionally transmit the structured record and corresponding audit-trace record to a downstream quality management or audit system.

Those skilled in the art will further appreciate that the example provided above is merely illustrative. Numerous variations may be implemented depending on industry, regulatory requirements, user behavior, or system configuration. The invention is not limited to any particular event type, attribute set, prompt sequence, or normalization strategy.

### Advantages of the Invention

The systems and methods described herein provide numerous advantages over existing approaches to documenting and processing quality events. By automatically analyzing free-text descriptions and comparing identified attributes to a regulatory attribute schema, the invention reduces the likelihood of omissions or ambiguities that commonly arise in manual documentation workflows. The dynamic prompting mechanism ensures that required, conditional, and dependency-linked fields are addressed promptly and systematically, resulting in more complete and accurate event records.

The invention also improves the efficiency of quality event processing by reducing the time and expertise required to review free-text submissions. Automated identification of missing information and structured generation of clarification prompts eliminates the need for manual back-and-forth communication between reviewers and personnel. This results in faster event closure, reduced administrative burden, and improved consistency across documentation efforts.

By normalizing user-provided information and structuring the resulting data into a machine-readable format, the invention enhances interoperability with downstream systems, including quality management systems, audit tools, and regulatory reporting platforms. The generation of a completeness score further provides an objective measure of record quality, supporting internal metrics, audits, and compliance reviews.

### Embodiments

The invention may be implemented in a wide variety of embodiments, several of which are described below. These embodiments are provided for purposes of illustration and are not intended to limit the scope of the claimed invention.

In one embodiment, the system is configured for use in aviation maintenance environments and is trained on historical maintenance reports, service bulletins, and regulatory directives. The regulatory attribute schema may include fields relating to aircraft identifiers, component locations, corrective actions, and verification procedures.

In another embodiment, the system is deployed in a pharmaceutical manufacturing facility. The regulatory attribute schema may define fields pertaining to batch identifiers, equipment cleaning steps, environmental monitoring results, deviations, and corrective and preventive actions. The terminology mapping table may normalize expressions associated with pharmaceutical-grade materials, contamination categories, or Good Manufacturing Practice (GMP) terminology.

In some embodiments, the system operates in a medical device manufacturing environment using a schema that includes device classification data, lot identifiers, nonconformance descriptions, root-cause coding, and risk-control validations. The domain-specific language model may be fine-tuned on production records, field-service logs, and regulatory submissions.

In certain embodiments, the system operates without requiring a graphical user interface. For example, the system may receive free-text input via an API or automated ingestion pipeline. In other embodiments, the system may accept voice input or OCR-derived text and apply the same schema comparison, prompting, normalization, and structuring processes.

In further embodiments, the system may process multiple free-text descriptions in batch mode, applying schema comparison, prompt logic, normalization, and structuring operations to each description independently or collectively. The completeness-validation process may generate completeness scores for each event or aggregate scores across multiple events.

In another embodiment, the regulatory attribute schema may be dynamically updated due to changes in regulatory requirements or organizational policies. When schema updates occur, the system may automatically re-evaluate previously generated machine-readable records and recompute completeness scores.

In yet another embodiment, the system may incorporate multilingual processing capabilities. Free-text descriptions may be provided in one language, normalized using language-specific rules, and structured into a machine-readable record in another language or in a language-independent format.

These and other embodiments will be apparent to those skilled in the art in view of the disclosures set forth herein.

In certain embodiments, the use of a domain-specific language model improves the accuracy of attribute extraction and ambiguity detection, particularly in industries where regulatory terminology is specialized or context-dependent. The terminology mapping table further contributes to consistent and standardized documentation by mapping free-text expressions to canonical schema terms.

Overall, the invention provides a scalable, repeatable, and automated approach to generating high-quality, schema-compliant event records, reducing reliance on subjective human judgment and improving an organization's ability to maintain accurate and complete quality documentation across diverse operational environments.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A computer-implemented method for constructing a regulatory-compliant quality-event record, the method executed by one or more processors and comprising:
a. receiving, via a graphical user interface, a free-text description of a quality event;
b. parsing the free-text description using a domain-specific language model fine-tuned on historical quality-event records to extract at least one detected event attribute;
c. comparing the detected event attribute to a predefined regulatory attribute schema stored in memory, the regulatory attribute schema comprising a mandatory field, a conditional field, and a dependency-linked field;
d. identifying, based on the comparing of step (c), at least one regulatory-required attribute missing from the free-text description;
e. generating, by a prompt-generation module, a clarification prompt that explicitly requests the missing regulatory-required attribute from step (d);
f. receiving, via the graphical user interface, a user response to the clarification prompt;
g. normalizing the free-text description and the user response using a rule-based normalization engine configured to map free-text phrases to a predefined regulatory terminology, thereby producing a normalized information;
h. structuring the normalized information into a machine-readable record comprising a plurality of discrete regulatory attribute fields; and
i. validating, using a completeness-validation module, the machine-readable record to satisfy each mandatory field defined by the regulatory attribute schema.

2. A non-transitory computer-readable medium storing instructions that, when executed by one or more processors, cause the performance of the method of claim 1.

3. The non-transitory medium of claim 2, wherein the instructions further cause generation of an audit-trace record identifying the detected missing attributes and corresponding user inputs.

4. The method of claim 1, wherein step (c) further comprises a step of determining whether a conditional field is required based on the detected event attribute.

5. The method of claim 1, wherein the regulatory attribute schema comprises at least one of an event onset time, a detection time, and a containment action.

6. The method of claim 1, wherein the domain-specific language model is configured to detect an ambiguous phrasing using a linguistic uncertainty score.

7. The method of claim 1, wherein step (g) further comprises a step of extracting a temporal expression and converting thereof into a discrete timestamp field.

8. The method of claim 1, wherein the clarification prompt comprises a request for the user to specify a missing containment action.

9. The method of claim 1, wherein step (h) further comprises a step of populating a JSON or XML event-object template.

10. The method of claim 1, wherein step (i) further comprises a step of assigning a completeness score and a step of determining whether the completeness score satisfies a predefined threshold.

11. A system for generating a regulatory-compliant quality-event record, comprising:
a. a graphical user interface configured to receive free-text description input and display a clarification prompt;
b. a regulatory attribute schema stored in computer memory and comprising a mandatory field, a conditional field, and a dependency-linked field;
c. a domain-specific language model stored in a non-transitory memory, the domain-specific language model is trained on one or more historical quality-event records and configured to extract at least one detected event attribute from free-text description;
d. a comparison module configured to compare the at least one detected event attribute to the regulatory attribute schema to identify a missing mandatory field;
e. a prompt-generation module configured to generate a clarification prompt requesting user input for the missing mandatory field of step (d);
f. a normalization engine configured to map user-provided text into a predefined regulatory terminology, thereby producing a normalized information;
g. a structuring module configured to convert the normalized information into a machine-readable record; and
h. a completeness-validation module configured to confirm that all mandatory fields defined by the regulatory attribute schema are satisfied.

12. The system for generating a regulatory-compliant quality-event record of claim 11, wherein the comparison module is further configured to identify a missing detection method.

13. The system for generating a regulatory-compliant quality-event record of claim 11, wherein the normalization engine is configured to apply a predefined terminology mapping table stored in memory.

14. The system for generating a regulatory-compliant quality-event record of claim 11, wherein the prompt-generation module is configured to generate the clarification prompt using dependency rules contained in the regulatory attribute schema.

15. The system for generating a regulatory-compliant quality-event record of claim 11, wherein the graphical user interface presents the clarification prompt only after a missing mandatory attribute is identified.
